(19) United States
(12) Patent Application Publication
(10) Pub. No.: US 2013/0042195 A1
(43) Pub. Date: Feb. 14, 2013

(54) Managing Workflow of Multiple Dependent Processes

(71) Applicants: Luda Svoyatsky, Streetsboro, OH (US); Robert Asper, Wadsworth, OH (US)

(72) Inventors: Luda Svoyatsky, Streetsboro, OH (US); Robert Asper, Wadsworth, OH (US)

(21) Appl. No.: 13/204,740

(22) Filed: Aug. 8, 2011

(51) Int. Cl. G06F 3/048

(52) U.S. Cl. 715/772

(57) ABSTRACT

A system for managing workflow of multiple dependent processes includes multiple dependent processes. A first process is configured to receive at least a first value and output at least a second value. A second process is configured to receive at least one of the first value and the second value and output at least a third value. The system further includes at least one network device capable of executing at least one process from the multiple dependent processes. A workflow management logic is operably connected to the at least one network device and includes a graphical user interface configured to graphically indicate status of at least one of the multiple dependent processes. A data store is operably connected to the workflow management logic and configured to store at least one of the first value, the second value and the third value.

### FIELD OF INVENTION

The present disclosure relates to the field of design process cycles. More particularly, the present disclosure relates to a method for managing a workflow of multiple dependent processes.

### BACKGROUND

Design processes often involve multiple dependent processes where each process performs a specific task along a design cycle. These multiple dependent processes often require inputs that represent the results or outputs of other processes in the cycle. Often these multiple dependent processes are disjointed with users or operators of the processes or the processes themselves having little or no information regarding the status of other processes in the cycle. Often inputs to the processes are not in the correct format or in the correct range for the processes to execute properly. This state of affairs is inefficient.

### SUMMARY OF THE INVENTION

In one embodiment, in a computer system having a graphical user interface comprising a display and a selection device employs a method of providing and selecting from a set of dependent processes reflected on the display. The method includes retrieving a set of data entries, where data entries represent inputs to the set of dependent processes and each process from the set of dependent processes requires a minimum number of inputs, and where at least some of the data entries represent outputs of the set of dependent processes. The method further includes receiving a process launching selection signal indicative of the selection device selecting a selected process from the set of dependent processes for launching. The method also includes launching the selected process in response to the process launching selection signal, if the minimum number of inputs for the selected process is present in the set of data entries.

In another embodiment, a system for managing workflow of multiple dependent processes includes multiple dependent processes. A first process is configured to receive at least a first value and output at least a second value. A second process is configured to receive at least one of the first value and the second value and output at least a third value. The system further includes at least one network device capable of executing at least one process from the multiple dependent processes. A workflow management logic is operably connected to the at least one network device and includes a graphical user interface configured to graphically indicate status of at least one of the multiple dependent processes. A data store is operably connected to the workflow management logic and configured to store at least one of the first value, the second value and the third value.

In yet another embodiment, a method for managing workflow of multiple dependent tire design processes is disclosed. The method includes receiving data representing a first output of a first process and storing the data representing the first output of the first process in a data store. The method also includes transmitting the data representing the first output of the first process to a second process requiring a minimum number of necessary inputs, wherein the first output of the first process is one of the minimum number of necessary inputs. The method further includes graphically indicating status of multiple processes including status of the second process based on at least one of whether the second process has received the minimum number of necessary inputs and whether execution of the second process has been completed.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example computer system for managing workflow of multiple dependent processes.

FIG. 2 illustrates an example system for managing workflow of multiple dependent processes.

FIG. 3 illustrates an example graphical user interface for managing workflow of multiple dependent processes.

FIG. 4 illustrates an example computer environment for managing workflow of multiple dependent processes.

FIG. 5 illustrates an example method for managing workflow of multiple dependent processes.

FIG. 6 illustrates an example method associated with a graphical user interface.

### DETAILED DESCRIPTION

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it should be appreciated that throughout the description, terms like processing, computing, calculating, determining, displaying, or the like, refer to actions and processes of a computer system, logic, processor, or similar electronic device that manipulates and transforms data represented as physical (electronic) quantities.

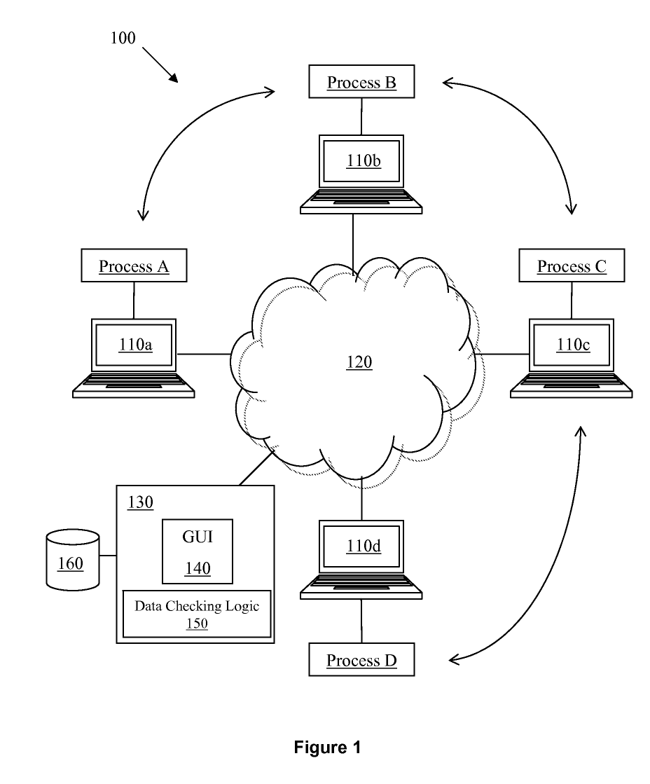

FIG. 1 illustrates an example computer system 100 for managing workflow of multiple dependent processes A-D. In one embodiment, multiple dependent processes A-D include processes involved in the design of tires. The processes A-D receive input values and produce output values. The processes A-D are dependent processes in that output values of a first process may represent input values for other processes. In one example, the process A receives input values and produces output values. The process B receives input values including output values from process A, and produces output values. The process C receives input values including output values from process A, from process B, or both, and produces output values. The process D receives input values including output values from process A, B, C, or combinations thereof, and produces output values. The processes A-D can also receive input values from sources other than dependent processes including from user input. The processes may also be iterative. For example, process A may produce an output value to process B, which in turn produces an output value to process B. It should be understood that these examples are not intended to be limiting and that any number of processes may be executed, any number of times, in any order.

In the illustrated embodiment, processes A-D are executed in network devices such as computers 110a-d. The computers 110a-d are each operably connected in a network 120. Exemplary networks include, without limitation, Local Area Networks (LAN), Wide Area Networks (WAN), the Internet, and wireless networks. The system 100 further includes a workflow management logic 130 that is also operably connected to the network 120. The workflow management logic 130 may reside or be executed in network devices including a server computer (not shown), computers 110a-d, combinations thereof, and so on.

The workflow management logic 130 includes a graphical user interface (GUI) 140 operable to, among other functions, indicate status of the processes A-D, launch or preclude the launch of the processes A-D under certain circumstances, receive user entered input values to processes A-D, indicate missing necessary input values to the processes A-D, and so on. The workflow management logic 130 further includes a data checking logic 150 that checks input values to determine whether the values are valid. Determining whether values are valid includes, but is not limited to, determining whether the values are in the correct format, whether the values are within an expected or required range, and so on. In one embodiment, the data checking logic 150 communicates with the GUI 140, and the GUI 140 indicates whether input values are valid as determined by data checking logic 150.

The system 100 further includes a data store such as database 160 that is operably connected to the workflow management logic 130. The database 160 stores data values including input and output values to the processes A-D. The database 160 may be a stand alone network device or it may reside in other network devices including a server computer (not shown), computers 110a-d, combinations thereof, and so on.

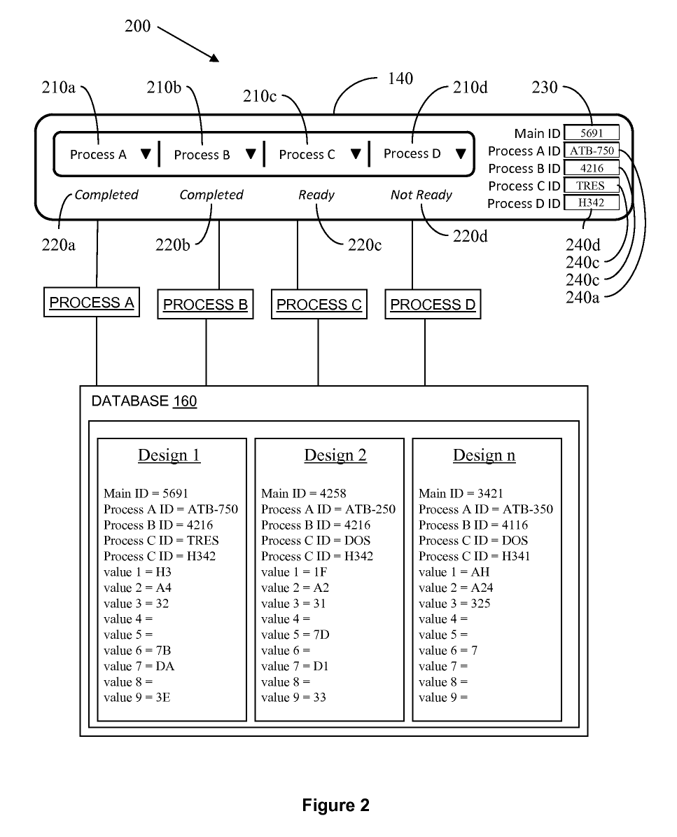

FIG. 2 illustrates an example system 200 for executing workflow management logic 130 and managing workflow of multiple dependent processes A-D. The system 200 includes the graphical user GUI 140. A user interacts with the GUI 140 via a display and a selection device (not shown). The GUI 140 includes process designators 210a-d and process status indicators 220a-d.

The process designators 210a-d are operable to obtain additional information about the processes A-D and for the user to launch the processes A-D under the right circumstances. For example, the user may select process designator 210a via the selection device to launch the process A. Similarly, the user may select the process designators 210b-d via the selection device to launch the processes B, C, and D, respectively.

The process status indicators 220a-d graphically indicate the status of the corresponding process. Process status indicators 220a-d include, but are not limited to, “Completed” to indicate that the execution of the process has been completed, “Ready” to indicate that the process is ready to be executed, and “Not Ready” to indicate that the process is not ready to be executed. In the illustrated embodiment, the process status indicators 220a-d indicate that the processes A-B have been completed, process C is ready, and process D is not ready.

In one embodiment, at least some of the processes A-D require a minimum number of input values before the process is ready to be executed or launched. The selected process will not launch and therefore will not execute if the minimum number of input values for the selected process is not present. In one embodiment, the GUI 140 graphically or otherwise indicates whether the minimum number of input values has been received. For example, the GUI 140 may indicate that the minimum number of input values to process B has or has not been received by highlighting the process designator 210b, by indicating via the process status indicator 220b that the process is “Ready” or “Not Ready,” by preventing or allowing launch of process B, or by combinations thereof.

In one embodiment, the system 200 includes the data checking logic 150 that checks input values to determine whether the received input values are valid. For example, the data checking logic may check input values to determine whether the values are in the correct format, whether the values are within an expected or required range, and so on. In one embodiment, the GUI 140 graphically or otherwise indicates whether input values are valid. For example, the GUI 140 may indicate that any received input value is not valid for its corresponding process by highlighting the process designator 210b, by indicating via the process status indicator 220b that the process is “Not Ready,” by preventing launch of process B, or by combinations thereof.

FIG. 2 further illustrates additional details of one embodiment of the database 160 for storing input values and output values of the processes A-D. When a data value is received by the system 200, be it an input value entered by a user or an output value from a process, the data value can be stored in the database 160 for later retrieval including for the data values to serve as input values to any of processes A-D. A workflow management logic (not shown) receives the data values and stores the data values in the database 160. The workflow management logic also provides the data values as input values to the processes A-D.

The GUI 140 further includes input fields for users to enter input values to processes A-D. In one embodiment, the GUI 140 includes a main ID field 230 that identifies the instant design for which the process status designators 220a-d currently indicate. In the illustrated embodiment, the database 160 stores multiple designs 1-n and their associated data values. A user can switch the instant design by changing the main ID field 230 to the corresponding design main ID. For example, in the illustrated embodiment, a user may switch from design “5691” to design “4258” by entering “4258” in the main ID field 230. In other embodiments, a user may switch the instant design by selecting a main ID corresponding to the desired design from a list or menu.

The GUI 140 further includes process ID fields 240a-d that provide additional identifying information regarding the processes A-D. In the illustrated embodiment, a tire design identified by the main ID field 230 as “5691” involves four processes: process A identified by the process A ID field 240a as “ATB-750,” process B by the process B ID field 240b identified as “4216,” process C identified by the process C ID field 240c as “TRES,” and process D identified by the process D ID field 240d as “H342.”

In the illustrated example of FIG. 2, the process A may require a single input value, value 1, which has a value of “H3.” After execution, the process A produces two output values, value 2=“A4” and value 3=“32.” The process B requires three input values, value 1=“H3,” value 2=“A4,” and value 6=“7B.” After execution, the process B produces one output value, value 7=“DA.” The process C requires three input values, value 1=“H3,” value 6=“7B,” and value 7=“DA.” After execution, the process C produces a single output value, value 5. Because the process C, although ready, has not been executed, the field for value 5 in the database 160 is empty. The process D requires three input values, value 1=“H3,” value 5, and value 7=“DA.” After execution, the process D produces two output values, value 4 and value 8. However, since value 5 is empty in the database 160, the process D is not ready and it cannot execute. Since the process D has not executed, the field for values 4 and 8 in the database 160 also remain empty.

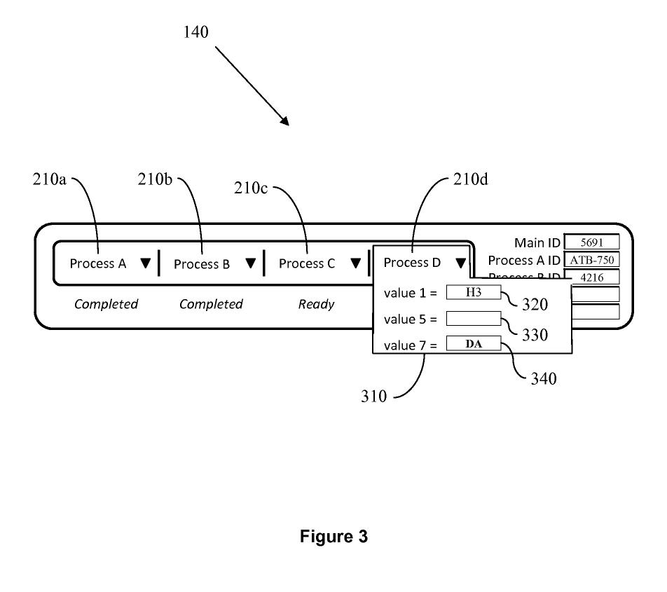

FIG. 3 illustrates an example GUI 140 for managing workflow of multiple dependent processes A-D. In one embodiment, the process designators 210a-d are operable to list input values. In the illustrated embodiment, the process designator 210d has been selected to open a pull down menu 310 that includes fields 320 and 330 that indicate necessary input values to process D. In the illustrated embodiment, field 320 indicates that value 1, a necessary input to process D has been received as “H3.” Field 330 indicates that value 5, another necessary input to process D has not been received. The user can enter the value 5 into field 330 to provide the missing input value to process D. Field 340 indicates that value 7, another necessary input to process D has been received as “DA.”

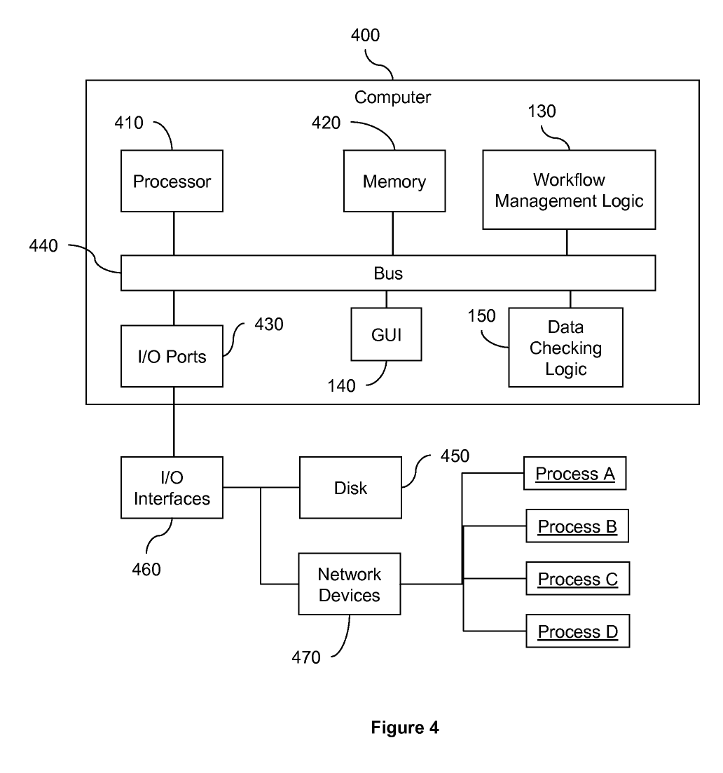

FIG. 4 illustrates a computer 400 that embodies the system 200 of FIG. 2. The computer 400 includes the GUI 140 a processor 410, a memory 420, and I/O Ports 430 operably connected by a bus 440. The computer 400 further includes the workflow management logic 130 connected to the bus 440 and configured to, among other functions, indicate status of processes A-D, launch the processes A-D, preclude the launching of the processes A-D, receive user entered input values to processes A-D, or indicate missing necessary input values to the processes A-D. Thus, the workflow management logic 130, whether implemented in computer 400 as hardware, firmware, software, or a combination thereof may provide means for indicating status of processes A-D, launching the processes A-D, precluding the launch of the processes A-D, receiving user entered input values to processes A-D, or indicating missing necessary input values to the processes A-D. The workflow management logic 430 may be permanently or removably attached to the computer 400.

In the illustrated embodiment, the computer 400 further includes the data checking logic 150 connected to the bus 440, which is configured to check input values to the processes A-D to determine whether the values are valid (e.g., whether the values are in the correct format, whether the values are within an expected or required range, and so on) and communicate with the workflow management logic 130 for the workflow management logic 130 to indicate whether input values are valid as determined by data checking logic 150. Thus, data checking logic 150, whether implemented in computer 400 as hardware, firmware, software, or a combination thereof may provide means for determining whether input values are valid and communicating with the workflow management logic 130 for the workflow management logic 130 to indicate whether the input values are valid as determined by data checking logic 150. The data checking logic 150 may be permanently or removably attached to the computer 400.

The processor 410 can be a variety of various processors including dual microprocessor and other multi-processor architectures. The memory 420 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 450 may be operably connected to the computer 400 via, for example, an I/O Interfaces (e.g., card, device) 460 and an I/O Ports 430. The disk 450 can include, but is not limited to, devices like a magnetic disk drive, a solid state disk drive, a floppy disk drive, a tape drive, a Zip drive, a flash memory card, an array of disks, such as a redundant array of inexpensive disks (RAID), or a memory stick. Furthermore, the disk 450 can include optical drives like a CD-ROM, a CD recordable drive (CD-R drive), a CD rewriteable drive (CD-RW drive), or a digital video ROM drive (DVD ROM). The disk 450 or memory 420 can store an operating system that controls and allocates resources of the computer 400. The disk 450 or memory 420 can store a database that stores data values to the process A-D.

The bus 440 can be a single internal bus interconnect architecture or other bus or mesh architectures. While a single bus is illustrated, it is to be appreciated that computer 400 may communicate with various devices, logics, and peripherals using other busses that are not illustrated (e.g., PCIE, SATA, Infiniband, 1394, USB, Ethernet). The bus 440 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The computer 400 may interact with input/output devices via I/O Ports 430 and I/O Interfaces 460. Input/output devices can include, but are not limited to, a keyboard, a microphone, a pointing and selection device, cameras, video cards, displays, disk 450, network devices 470, and the like. The I/O Ports 430 can include but are not limited to, serial ports, parallel ports, and USB ports.

The computer 400 can operate in a network environment and thus may be connected to network devices 470 via the I/O Interfaces 460, or the I/O Ports 430. Through the network devices 470, the computer 400 may interact with a network (e.g., network 120 in FIG. 1). Through the network, the computer 400 may be logically connected to remote computers. Through the network, the computer 400 may be logically connected to processes A-D. The networks with which the computer 400 may interact include, but are not limited to, a local area network (LAN), a wide area network (WAN), and other networks. The network devices 470 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 470 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

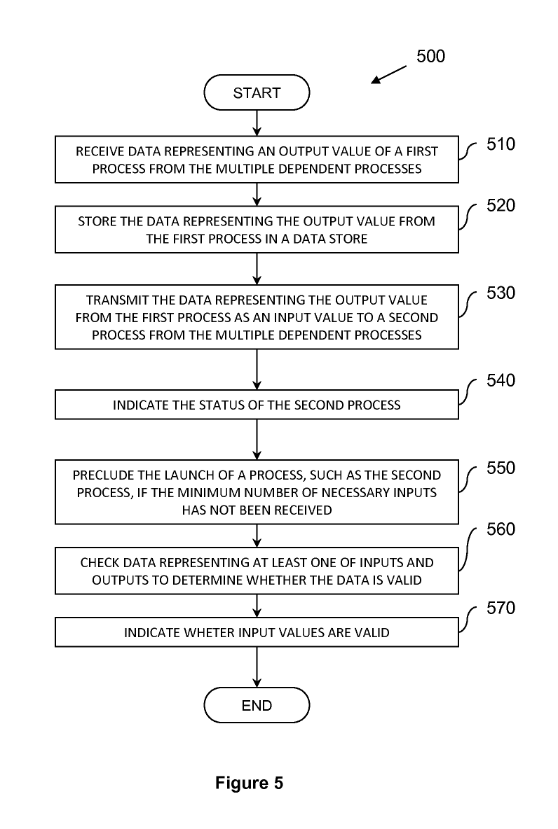

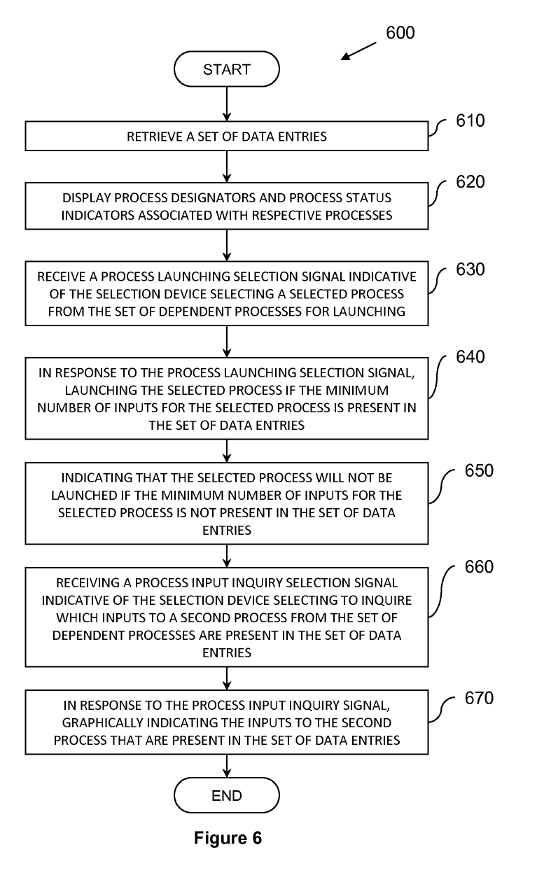

Example methods may be better appreciated with reference to the flow diagrams of FIGS. 5 and 6. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform one or more of the methods of FIGS. 5 and 6. While the methods are described being provided on a computer-readable medium, it is to be appreciated that other example methods described herein can also be provided on a computer-readable medium.

While FIGS. 5 and 6 illustrate various actions occurring in serial, it is to be appreciated that various actions illustrated in FIGS. 5 and 6 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 5 illustrates a method 500 for managing workflow of multiple dependent processes. The method 500 includes, at 510, receiving data representing an output value of a first process from the multiple dependent processes. The method 500 further includes, at 520, storing the data representing the output value from the first process in a data store. The method 500 further includes, at 530, transmitting the data representing the output value from the first process as an input value to a second process from the multiple dependent processes. In one embodiment, the second process requires a minimum number of necessary inputs and the output value from the first process represents one of the minimum number of necessary inputs. The method 500 further includes, at 540, graphically indicating the status of the second process. The status indication includes, but is not limited to, whether the second process has received the minimum number of necessary inputs or whether execution of the second process has been completed.

In one embodiment, the method 500 further includes providing a graphical user interface that is operable to launch at least one of the multiple dependent processes upon user interaction with the graphical user interface. In one embodiment, the method 500 further includes, at 550, precluding the launch of a process, such as the second process, if the minimum number of necessary inputs has not been received.

In one embodiment, the method 500 includes receiving data representing an input to the second process and communicating the data representing the input to the second process to at least one of the second process and the data store. For example, a user may enter input data via the graphical user interface. In another example, the input data may be the output of another process. The input data is received and then communicated to the second process, the data store, or both.

In one embodiment, the method 500 includes, at 560, checking data representing at least one of inputs and outputs to determine whether the data is valid. For example, the method 500 may check input values to determine whether the values are in the correct format, whether the values are within an expected or required range, and so on. In one embodiment, the method 500 includes, at 570, graphically or otherwise indicating whether input values are valid. For example, the method 500 may indicate that any received input value is not valid for its corresponding process by highlighting a process designator associated with the process, by indicating via a process status indicator that the process is “Ready” or “Not Ready,” by preventing or allowing launch of the process, or by combinations thereof.

FIG. 6 illustrates an example method 600 associated with a graphical user interface (GUI) and providing and selecting from a set of dependent processes reflected on the GUI. The method 600 may be performed in a computer system having a graphical user interface that includes a display and a selection device. The method 600 may include providing and selecting from a set of data entries on the display. Thus, in one example, the method 600 includes, at 610, retrieving a set of data entries. In one embodiment, data entries represent inputs to the set of dependent processes and each process from the set of dependent processes requires a minimum number of inputs, and at least some of the data entries represent outputs of the set of dependent processes.

The method 600 also includes, at 620, displaying process designators and process status indicators associated with respective processes and, at 630, receiving a process launching selection signal indicative of the selection device selecting a selected process from the set of dependent processes for launching. The process launching selection signal may be received in response to, for example, a mouse click, a key press, a voice command, and so on. At 640, in response to the process launching selection signal, the method 600 includes launching the selected process if the minimum number of inputs for the selected process is present in the set of data entries.

In one embodiment, in response to the process launching selection signal, the method 600 includes, at 650, indicating that the selected process will not be launched if the minimum number of inputs for the selected process is not present in the set of data entries.

In one embodiment, the method 600 includes, at 660, receiving a process input inquiry selection signal indicative of the selection device inquiring which inputs for a second process from the set of dependent processes are present in the set of data entries, and, in response to the process input inquiry signal, at 670, graphically indicating the inputs to the second process that are present in the set of data entries.

In one embodiment, the method 600 includes checking at least some of the data entries to determine whether the checked data entries are valid. For example, the method 600 may check data entries to determine whether they are in the correct format, within an expected or required range, and so on. In one embodiment, the method 600 includes graphically indicating whether data entries are valid.

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. In a computer system having a graphical user interface comprising a display and a selection device, a method of providing and selecting from a set of dependent processes reflected on the display, the method comprising:
retrieving a set of data entries, where data entries represent inputs to the set of dependent processes and each process from the set of dependent processes requires a minimum number of inputs, and where at least some of the data entries represent outputs of the set of dependent processes;
receiving a process launching selection signal indicative of the selection device selecting a selected process from the set of dependent processes for launching; and
in response to the process launching selection signal, launching the selected process if the minimum number of inputs for the selected process is present in the set of data entries.

2. The method of claim 1, further comprising:
in response to the process launching selection signal, indicating that the selected process will not be launched if the minimum number of inputs for the selected process is not present in the set of data entries.

3. The method of claim 1, further comprising:
graphically indicating status of at least some of the processes from the set of dependent processes.

4. The method of claim 1, further comprising:
receiving a process input inquiry selection signal indicative of the selection device selecting to inquire which inputs to a second process from the set of dependent processes are present in the set of data entries; and
in response to the process input inquiry signal, graphically indicating the inputs to the second process that are present in the set of data entries.

5. The method of claim 1, further comprising:
receiving from a user via the graphical user interface one or more data entries that do not represent outputs of the set of dependent processes; and
storing in a database the data entries that represent outputs of the set of dependent processes and the data entries that do not represent outputs of the set of dependent processes.

6. The method of claim 1, further comprising:
checking at least some of the data entries to determine whether the checked data entries are valid.

7. A system for managing workflow of multiple dependent processes, the system comprising:
multiple dependent processes including:
a first process configured to receive at least a first value and output at least a second value,
a second process configured to receive at least one of the first value and the second value and output at least a third value;
at least one network device capable of executing at least one process from the multiple dependent processes;
a workflow management logic operably connected to the at least one network device and including a graphical user interface configured to graphically indicate status of at least one of the multiple dependent processes; and
a data store operably connected to the workflow management logic and configured to store at least one of the first value, the second value and the third value.

8. The system of claim 7, wherein the graphical user interface is operable to launch at least one of the first process and the second process.

9. The system of claim 8, wherein the workflow management logic is configured to preclude the launch of the second process if the at least one of the first value and the second value has not been received.

10. The system of claim 8, wherein the second process is configured to receive a fourth value, wherein the graphical user interface is configured to receive the fourth value from a user for the workflow management logic to communicate the fourth value to at least one of the second process and the data store, and wherein the workflow management logic is configured to preclude the launch of the second process if the fourth value has not been received.

11. The system of claim 7, wherein the graphical user interface is configured to indicate whether the first value has not been received.

12. The system of claim 7, wherein the second process is configured to receive a fourth value and wherein the graphical user interface is configured to receive the fourth value from a user for the workflow management logic to communicate the fourth value to at least one of the second process and the data store.

13. The system of claim 7, wherein the workflow management logic includes data checking logic configured to check at least one of the first value, the second value and the third value to determine whether the value is within a corresponding legal range.

14. A method for managing workflow of multiple dependent tire design processes, the method comprising:
receiving data representing a first output of a first process;
storing the data representing the first output of the first process in a data store;
transmitting the data representing the first output of the first process to a second process requiring a minimum number of necessary inputs, wherein the first output of the first process is one of the minimum number of necessary inputs; and
graphically indicating status of multiple processes including status of the second process based on at least one of whether the second process has received the minimum number of necessary inputs and whether execution of the second process has been completed.

15. The method of claim 14, further comprising:
providing a graphical user interface operable to launch at least one of the first process and the second process; and
launching at least one of the first process and the second process upon user interaction with the graphical user interface.

16. The method of claim 14, further comprising:
providing a graphical user interface capable of launching the second process; and
precluding the launch of the second process if at least one of the minimum number of necessary inputs has not been received.

17. The method of claim 14, further comprising:
receiving data representing an input to the second process; and
communicating the data representing the input to the second process to at least one of the second process and the data store.

18. The method of claim 17, wherein the data representing the input to the second process is received from a user by the graphical user interface for the workflow management logic to communicate the data representing the input to at least one of the second process and the data store.

19. The method of claim 14, further comprising:
indicating via a graphical user interface whether one or more inputs from the minimum number of necessary inputs has not been received.

20. The method of claim 14, further comprising:
checking data representing at least one of inputs and outputs to determine whether the data is within corresponding legal ranges.
